(19) United States
(12) Patent Application Publication
(10) Pub. No.: US 2005/0022419 A1
(43) Pub. Date: Feb. 3, 2005

(54) Disposition for collecting suspended particles to be applied in grain drying machines

(75) Inventor: Marcelo Norberto Valfiorani, Buenos Aires (AR)

Correspondence Address: NORRIS, MCLAUGHLIN & MARCUS, P.A., 875 THIRD AVE, 18TH FLOOR, NEW YORK, NY, 10022, US

(73) Assignee: INGENIERIA MEGA S.A., Lincoln (AR)

(21) Appl. No.: 10/861,091

(22) Filed: Jun. 4, 2004

(30) Foreign Application Priority Data
Apr. 15, 2002 (AR) P 020101368

(51) Int. Cl. F26B 17/00

(52) U.S. Cl. 34/589

(57) ABSTRACT

An assembly is provided for collecting particles suspended in an air flow in grain drying machines. The assembly has a tubular structure formed by a primary cyclone and a secondary cyclone, wherein the primary cyclone has an inlet portion connected to a respective dryer air outlet and an outlet portion where an air particle separation zone is defined, and wherein the primary cyclone has a first outlet for air free of particles, and a second air outlet for air with particles to flow towards the secondary cyclone, with the particles separation zone including an inner cylinder defining a chamber for conducing particles to the secondary cyclone.

### BACKGROUND OF THE INVENTION

1. Field of the Invention

The present invention refers to disposition for collecting suspended particles to be applied in grain drying machines, particularly, it refers to a disposition for grain dryers of the type that comprises a drying tower that has at least one column with three or more air-with-particles-in-suspension outlets which result of drying process. For example, air outlets are vertically aligned to each other in these kinds of grain dryers, and an aspiration turbine is connected with each one of said air outlets, which aspirate air used in the drying process and expels it out.

2. Description of the Prior Art

As anybody having skill in the art knows, grains do not have to be stored if they are not dry, being allowed certain percentage of humidity, for example, less than 15% as a limit to consider said grains dry, this value depends on several factors, such as the climatic conditions of the corresponding region. In artificial grain drying techniques, the air expelled by drying machines by means of its turbines includes a lot of particles in suspension, which affect the environment next to the dryers. This situation generates conflict zones because of the contamination of the atmosphere, specially when these machines are disposed near houses, offices, ways, just to mention some examples selected between diverse concrete examples.

In order to solve such disadvantages, the air used during the process of drying of grains is has to be filtered or to purified in an efficient and safe way, so as separating the particles in suspension. The disposition of the present invention has been developed with that purpose; the structure of the disposition of the present invention presents a conformation that lets to reduce considerably the solid concentration in the air expelled by the dryer. To achieve that effect, it was taken on count the necessity to satisfy two essential aspects, such as to catch the greater amount of particles possible and to avoid dryer's turbines to lose efficiency. In this last aspect, it is possible to indicate that the efficiency losses of dryer's turbines reduce the drying air volume and, consequently, said losses reduce the production measured in ton/hr (ton/hour), is to say tons per hour, of dried grain. Because of it previously explained, it is emphasized that in the proposed embodiment, as the following description will be make evident, it have been contemplated and adjusted each one of the dimensions of the parts that compose it, having achieved in that way beside the point satisfactory results.

### SUMMARY OF THE INVENTION

It is therefore an object of the present invention to provide a disposition for collecting suspended particles to be applied in grain drying machines, wherein the drying machine comprises a drying tower that includes, in general, at least one tower with several air-with-particles-in-suspension outlets and each one of said outlets incorporates an air impelling turbine which impels air outside, including/understanding this disposition, by each exit of the air used in the dryer, a tubular structure formed by a primary cyclone and a secondary cyclone, having this primary cyclone an inlet portion of connected to the respective dryer air outlet and an outlet portion wherein it is defined an air particles separation zone where the primary cyclone presents an outlet mouth which expels out air with no particles and an outlet mouth which expels air with particles towards said secondary cyclone, including said particles separating zone an inner cylinder that defines, between the its outer surface and the surrounding inner surface of the primary cyclone, a particles derivation chamber which derivates said particles towards the secondary cyclone, being said derivation chamber and said secondary cyclone tangentially communicated.

### BRIEF DESCRIPTION OF DRAWINGS

For better understanding and clarity of the object of the present invention, it have been illustrated in several figures, where it have been represented in the preferred forms of accomplishment, everything exemplary:

FIG. 1 is a lateral in-elevation view that schematically shows a grain drying machine that incorporates the disposition for collecting suspended particles object of the present invention, wherein said disposition has been illustrated slightly separated from the drying tower for better understanding.

FIG. 2 is a frontal in-elevation schematic view of the drying tower of FIG. 1, wherein the collecting disposition has not been illustrated to let to visualize the air impelling turbines from the drying tower towards the disposition.

FIG. 3 is a partial in-elevation lateral view that schematically shows the constructive characteristics of the disposition for collecting suspended particles of the present invention.

FIG. 4 is a frontal in-elevation view that schematically shows constructive characteristics of the collecting disposition of the present invention in agreement with what have been illustrated in FIG. 3.

FIG. 5 is a cross-sectional view obtained by means of cutting through line A-A indicated in FIG. 4.

FIG. 6 is a cross-sectional view obtained by means of cutting through line B-B indicated in FIG. 4.

FIG. 7 is a partial in perspective view in perspective generally showing the aspect of a grain-drying machine that incorporates the collecting disposition according to the present invention.

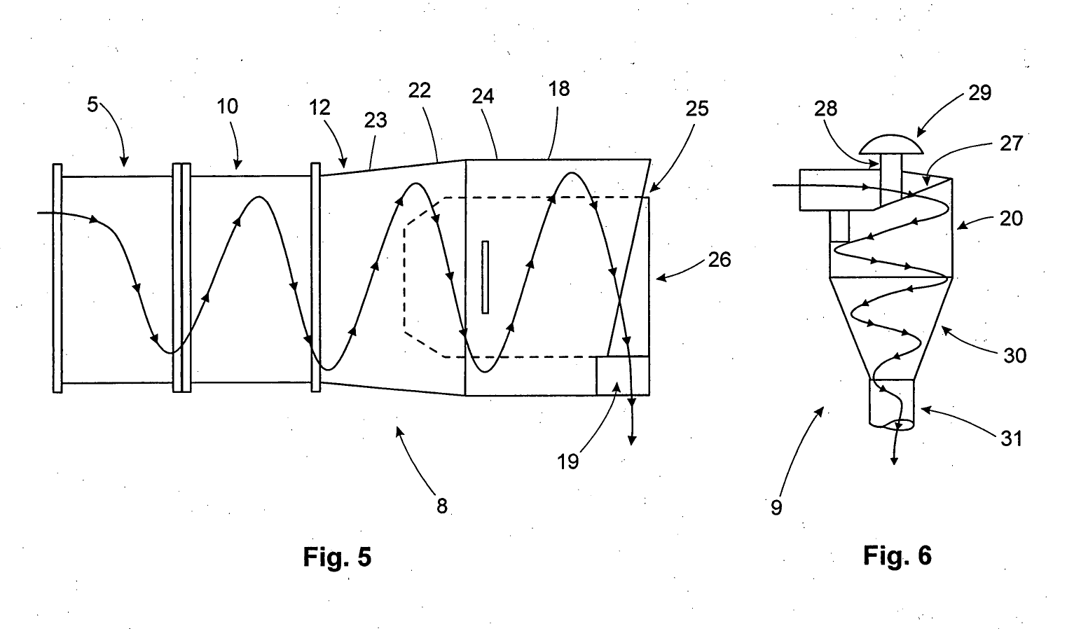

Note: Circulation trajectory of air with particles in suspension is indicated in FIGS. 5 and 6, by means of arrow lines.

### DESCRIPTION OF THE PREFERRED EMBODIMENTS

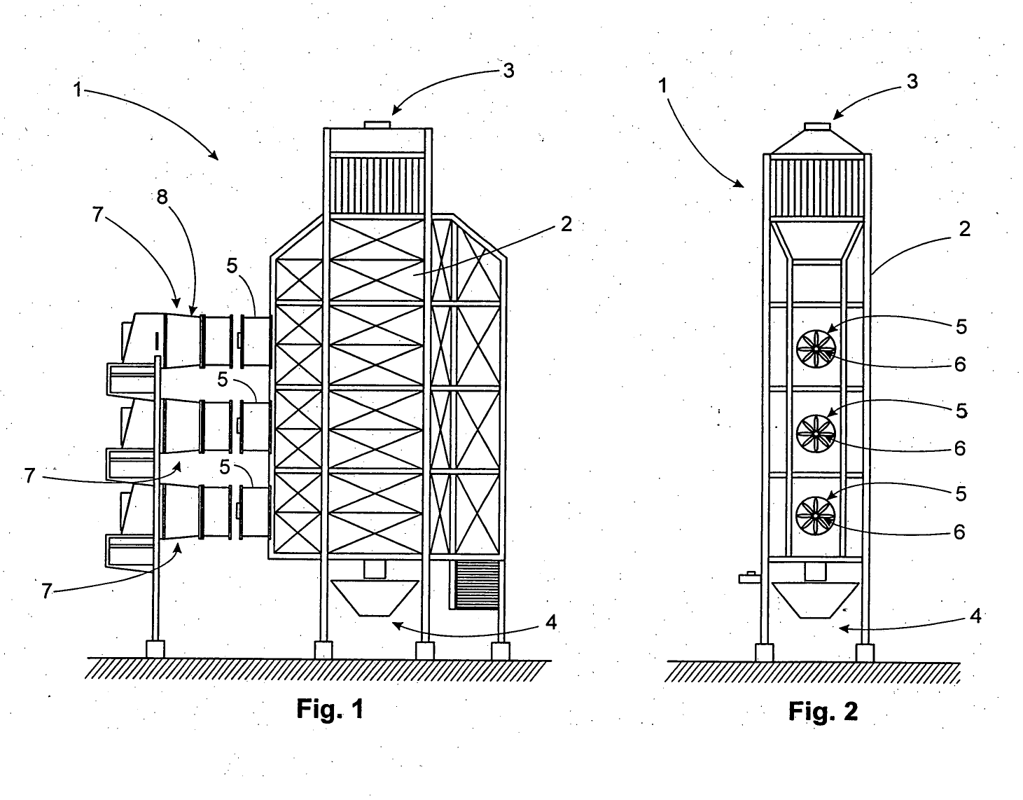

Referring firstly to FIGS. 1 and 2, a grain drying machine is shown, generally indicted 1, that comprises a drying tower 2 that includes an upper end portion 3 wherein grain to be dried are loaded and a lower end portion 4 wherefrom dry grains exit. As it is observed in this example, tower 2 is formed by means of a column which has three or more air with-particles-in-suspension outlets but exits 5 of, which are vertically aligned to each other and each one includes a turbine 6 which aspirates the air from the inside portion of the dryer tower 2 towards the outer atmosphere.

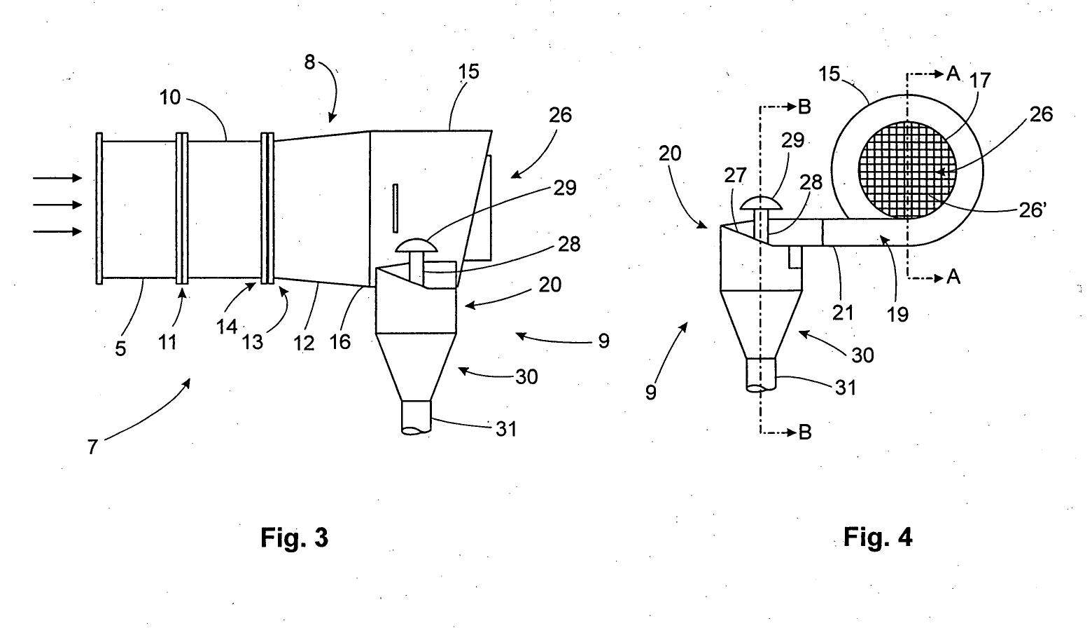

According to what is illustrated thing in FIG. 1, each one of air outlets 5 of the dryer 1 includes a disposition of the present invention conformed by a tubular structure 7 which is comprised by a primary cyclone 8 and, as it can be better seen in FIG. 3, a secondary cyclone 9. In the described preferred accomplishment, the primary cyclone 8 has a first straight tubular section 10, whose first end portion 11 defines an air inlet connected to respective outlet 5 of the dryer 1, a truncated cone tubular section 12, connected from its edge 13 which presents a diameter smaller than the diameter of a second end portion 14 of the straight tubular section 10, and a second straight tubular section 15 that extends from the edge 16 which is the larger diameter edge of said truncated cone tubular section 12.

Section 15 of cyclone 7 is an outlet portion wherein in its inside part a particle separation zone is defined that includes, as it is clearly shown in FIG. 5, an inner cylinder 17 which is coaxial with section 15 and defines, between its outer surface and the surrounding inner surface of section 15, a particle derivation chamber 18 which derivates particles towards the secondary cyclone 9 with which it is tangentially connected (as it can be seen in the figure), including said chamber 18 a lower outlet wherein it is connected a secondary cyclone upper portion 20 through an intermediate conduit 21.

In order to lead air with particles in suspension towards secondary cyclone 9, primary cyclone section 15 finishes in a spiral shaped plate (front side) in whose smaller diameter end portion (previous) the inlet of air with particles in the chamber 18 is defined and whose greater-diameter end portion is communicated with outlet 19.

Furthermore, FIG. 5 shows that inner cylinder 17 has a first end portion 22 where a truncated-cone-shaped air inlet 23 is defined, and a straight section 24 that ends in a second end portion 25 wherein a mouth 26 is arranged. This mouth 26 defines an exit towards the outer atmosphere for air with no particles. A protective grid 26′ is arranged in said mouth 26.

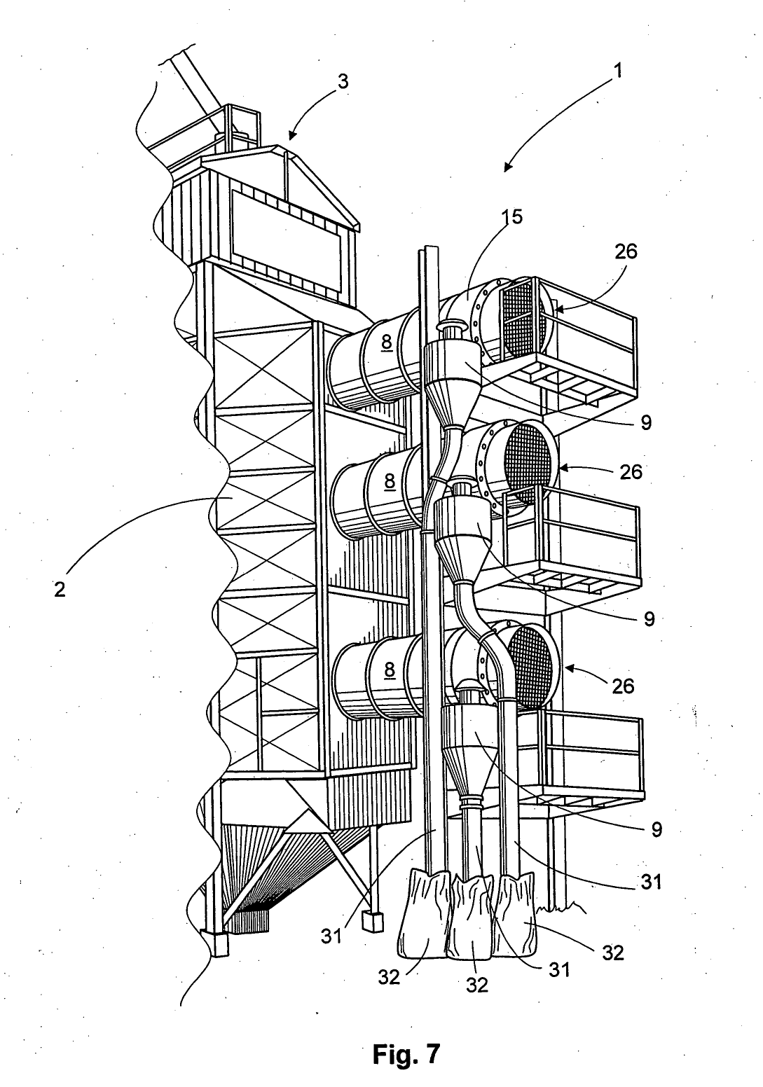

FIGS. 4 and 6 show that upper portion 20 of secondary cyclone 9 is tubular straight, and includes an upper wall 27, inclined on one side, an air unloading tube 28 sticks out over said upper wall 27, said unloading tube 28 ends in an upper protective cover 29. Below said upper inclined portion 27, secondary cyclone 9 includes a truncated-cone-shaped lower portion 30 whose less-diameter end portion is arranged downwards and wherein a the upper end portion of pipe 31 is connected end of descendent particle conduction that was separated of the drying air. As shown in FIG. 7, wherein can be seen the general conformation of the disposition of the present invention applied to a grain drying machine, a particle receiving bag 32 is placed in the lower end portion of said pipe 31.

It is possible to indicate that when taking to the practice the preferred embodiment previously described, section 10 of primary cyclone 8 is 1000 mm diameter and is 600 mm length. This way, according to tests that have been made, it was obtained a greater run distance and time to make possible that particles propagate towards the inner wall of the truncated cone section 12, whose length is of 1100 mm, and this way said particles reach the chamber 18 to be lately derived towards the secondary cyclone 9. The greater portion of truncated cone section 12 is 1175 mm diameter and the inner cylinder 17 is 950 mm diameter. On the other hand, the section of inlet which lets air to flow to secondary cyclone 9 is rectangular, it is 170 mm length and 280 mm height, and it is 600 mm diameter, which lets to reduce considerably the air circulation speed and particles precipitate by action of their own weight.

1. Disposition for collecting suspended particles to be applied in grain drying machines, wherein the drying machines are those that include a drying tower that presents, in general, at least one air-with-particles-in-suspension outlet, which incorporates an aspiration turbine which aspirates air from the dryer towards the outer atmosphere, wherein said disposition for collecting particles comprises, by each air outlet used in the dryer, a tubular structure formed by a primary cyclone and a secondary cyclone, having said primary cyclone an inlet portion connected to the respective dryer air outlet and an outlet portion where a zone of particle separation is defined where in said zone the primary cyclone presents a first outlet wherefrom air without particles is expelled outside and a second outlet wherefrom air with particles is expelled towards said secondary cyclone, including said separation zone an inner cylinder that defines, between its outer surface and the surrounding inner surface of the primary cyclone, a particle derivation chamber that derivates particles towards the secondary cyclone, being said derivation chamber and said secondary cyclone tangentially connected.

2. Disposition according to claim 1, wherein said derivation chamber has a lower outlet wherefrom it is connected with an upper portion of said secondary cyclone by means of an intermediate conduit.

3. Disposition according to claims 1 or 2, wherein said primary cyclone is comprised by a first straight tubular section, wherein said air inlet portion is defined, a truncated cone tubular section, connected from its less diameter edge with said straight tubular section, and a second straight tubular section that extends from the most diameter edge of said truncated cone tubular section.

4. Disposition according to claim 3, characterized because said second straight tubular section ends in a spiraled developed plate wherein in its less diameter end portion an air inlet is defined, which lets air with particles to flow into the derivation chamber, and whose most diameter end portion is connected with said outlet that lets air with particles to flow towards the secondary cyclone.

5. Disposition according to claims 1 to 4, wherein said inner cylinder presents a first end portion where a truncated cone shaped air inlet and a straight section are defined, ending said straight section in a second end portion where said primary cyclone outlet is defined.

6. Disposition according to any of the preceding claims, wherein the upper portion of said secondary cyclone is straight and tubular, from its upper wall an air unload tube that ends in an end portion covered by a protective cover sticks out, presenting said secondary cyclone a truncated cone shaped lower portion whose less diameter end portion is arranged downwards and is connected with the upper portion of a pipe which conducts and unloads separated particles.

7. Disposition according to 6, wherein particles receiving bag is placed in the lower end portion of said particles conduction pipe.
